(19) United States
(12) Patent Application Publication
(10) Pub. No.: US 2026/0163945 A1
(43) Pub. Date: Jun. 11, 2026

(54) METHOD AND APPARATUS FOR GROUPING OBJECTS FOR SENSOR-SHARING SERVICE

(71) Applicant: KOREA NATIONAL UNIVERSITY OF TRANSPORTATION Industry-Academic Cooperation Foundation, Chungju-si (KR)

(72) Inventor: Cheol MUN, Yongin-si (KR)

(21) Appl. No.: 18/987,279

(22) Filed: Dec. 19, 2024

(30) Foreign Application Priority Data
Dec. 11, 2024 (KR) 10-2024-0183998

(51) Int. Cl. H04L 67/12; H04W 4/38

(52) U.S. Cl. CPC H04L 67/12; H04W 4/38

(57) ABSTRACT

Disclosed herein are a grouping method and apparatus for a sensor-sharing service. A computer implementation method includes detecting objects based on information obtained from a sensor, generating an object group by grouping at least a portion the objects, and generating a sensor data sharing message including information on the objects. The sensor data sharing message includes representative dynamic information that is generated based on information on each of the objects included in the object group.

### CROSS REFERENCE TO RELATED APPLICATION

The present application claims priority to Korean Patent Application 10-2024-0183998 filed Dec. 11, 2024, the entire contents of which are incorporated herein for all purposes by this reference.

### TECHNICAL FIELD

The present disclosure relates to a sensor sharing method, and more particularly, to an apparatus and method for grouping objects in a sensor-sharing service.

### BACKGROUND

With the advance of autonomous driving technology, the number of autonomous vehicles is on the rise. An autonomous vehicle detects surrounding objects and environments by using its onboard sensors and drives based on the detection. For safety of such an autonomous vehicle, the autonomous vehicle has to detect surrounding objects and environments without missing. However, the performance, number and positions of sensors installed in an autonomous vehicle have limitations. Accordingly, there may occur a blind spot where the autonomous vehicle fails to detect an object from the sensors.

To solve the problem of failure to detect an object in a blind spot, a sensor-sharing service has been proposed. The sensor-sharing service refers to a service that detects an object through infra sensors, that is, sensors outside a vehicle, and transmits information on the object to the vehicle through a message. For the sensor-sharing service, Sensor Data Sharing Message (SDSM) has been proposed as a standard for message format. However, there is a problem that the number of objects, on which information is transmissible using SDSM, is limited.

### SUMMARY

An object of the present disclosure is to provide a method and apparatus for transmitting object information for a sensor-sharing service.

An object of the present disclosure is to provide a method and apparatus for compressing object information for a sensor-sharing service.

An object of the present disclosure is to provide a method and apparatus for transmitting information on more objects through object grouping for a sensor-sharing service.

An object of the present disclosure is to provide a method and apparatus for generating information related to an object group for a sensor-sharing service.

The technical problems solved by the present disclosure are not limited to the above technical problems and other technical problems which are not described herein will be clearly understood by a person having ordinary skill in the technical field, to which the present disclosure belongs, from the following description.

According to an aspect of the present disclosure, a computer implementation method for sensor sharing is provided. The method includes detecting objects based on information obtained from a sensor, generating an object group by grouping at least a portion the objects, and generating a sensor data sharing message including information on the objects. The sensor data sharing message includes representative dynamic information that is generated based on information on each of objects included in the object group.

According to another embodiment of the present disclosure, the representative dynamic information includes at least one of a representative position, a representative heading, a representative speed, or a representative acceleration, and the representative dynamic information corresponds to a position, a heading, a speed, or an acceleration of the object group.

According to still another embodiment of the present disclosure, the sensor data sharing message includes a type and an ID of the object group, and the type of the object group is identical to a type of the objects included in the object group.

According to yet another embodiment of the present disclosure, the grouping is performed based on dynamic information of the objects, and the object group includes a same type of objects.

According to yet another embodiment of the present disclosure, the generating of the object group includes calculating a difference of the dynamic information of the objects and generating the object group by grouping objects with the difference being equal to or below a threshold.

According to yet another embodiment of the present disclosure, the dynamic information includes a position, a speed, a movement heading, or an acceleration.

According to yet another embodiment of the present disclosure, the sensor data sharing message further includes additional information on the object group, and the additional information includes at least one of a shape of the object group, a number of the objects included in the object group, a position of each of the objects included in the object group, and a size of each of the objects included in the object group.

According to another aspect of the present disclosure, a sensor sharing apparatus may be provided. The apparatus includes at least one processor and a memory for storing instructions, and the at least one processor is configured to, by executing the instructions, detect objects based on information obtained from a sensor, to generate an object group by grouping at least a portion the objects, and to generate a sensor data sharing message including information on the objects. The sensor data sharing message includes representative dynamic information that is generated based on information on each of objects included in the object group.

The features briefly summarized above with respect to the present disclosure are provided as an example only to explain the detailed description and are not construed to limit the scope of the present disclosure.

According to the present disclosure, it is possible to provide an apparatus and method for transmitting information on more objects by grouping objects and using one SDSM.

The effects obtainable from the present disclosure are not limited to the above-mentioned effects, and other effects not mentioned herein will be clearly understood by those skilled in the art through the following descriptions.

### BRIEF DESCRIPTION OF DRAWINGS

FIG. 1 illustrates an example of a sensor-sharing service system.

FIG. 2 illustrates a structure of a multi-access edge computer (MEC).

FIG. 3 illustrates an example of object detection according to an embodiment of the present disclosure.

FIG. 4 illustrates an example of grouping according to an embodiment of the present disclosure.

FIG. 5 illustrates an example of an information transmission procedure of a plurality of objects according to an embodiment of the present disclosure.

FIG. 6 illustrates an example of a group procedure according to an embodiment of the present disclosure.

FIG. 7 illustrates a shape of a group including vehicles as objects according to an embodiment of the present disclosure.

FIG. 8 illustrates a shape of a group including pedestrians as objects according to an embodiment of the present disclosure.

FIG. 9 illustrates an example of a sensor data sharing message (SDSM) to which grouping is not applied.

FIG. 10 illustrates an example of an SDSM to which grouping is applied.

### DETAILED DESCRIPTION

Hereinafter, embodiments of the present disclosure will be described in detail with reference to the accompanying drawings such that those skilled in the art may easily implement the embodiments. However, the present disclosure may be implemented in many different forms and is not limited to the embodiments described herein.

In describing the embodiments, detailed descriptions of known configurations or functions will be omitted when it is determined that the detailed descriptions cloud the subject matter of the disclosure. In addition, in the drawings, a portion that is irrelevant to the description of the present disclosure is omitted, and similar reference numerals refer to similar portions.

In the present disclosure, when a component is said to be “connected”, “coupled” or “linked” with another component, this may include not only a direct connection, but also an indirect connection in which another component exists in the middle therebetween. In addition, when a component “includes” or “has” other components, it means that other components may be further included rather than excluding other components unless the context clearly indicates otherwise.

In the present disclosure, terms such as first and second are used only for the purpose of distinguishing one component from other components, and do not limit the order, importance, or the like of components unless otherwise noted. Accordingly, within the scope of the present disclosure, a first component in one exemplary embodiment may be referred to as a second component in another exemplary embodiment, and similarly, a second component in one exemplary embodiment may also be referred to as a first component in another exemplary embodiment.

In the present disclosure, components that are distinguished from each other are intended to clearly describe each of their characteristics, and do not necessarily mean that the components are separated from each other. That is, a plurality of components may be integrated into one hardware or software unit, or one component may be distributed to be configured in a plurality of hardware or software units. Therefore, even when not stated otherwise, such integrated or distributed exemplary embodiments are also included in the scope of the present disclosure.

In the present disclosure, components described in various exemplary embodiments do not necessarily mean essential components, and some may be optional components. Accordingly, an exemplary embodiment consisting of a subset of components described in an exemplary embodiment is also included in the scope of the present disclosure. In addition, exemplary embodiments including other components in addition to the components described in the various exemplary embodiments are included in the scope of the present disclosure.

In the present disclosure, each of such phrases as “A or B,” “at least one of A and B,” “at least one of A or B,” “A, B, or C,” “at least one of A, B, and C,” and “at least one of A, B, C or combination thereof,” may include any one of, or all possible combinations of the items enumerated together in a corresponding one of the phrases.

Advantages and features of the present disclosure and a method for achieving the same will become apparent with reference to the embodiments described in detail together with the accompanying drawings. However, the present disclosure is not limited to the embodiments presented below but may be implemented in various forms, and the embodiments are provided to completely disclosure the present invention and to completely inform those skilled in the art of the scope of the invention.

An autonomous vehicle uses sensors (e.g., camera, Lidar, radar) installed in the vehicle to perceive and determine surrounding situation and moves based on determinations. A camera, Lidar and radar, that is, sensors installed in the vehicle, use light, laser and electric wave, respectively. Accordingly, the autonomous vehicle is incapable of perceiving a situation of a blind spot. In order to solve this problem, a sensor-sharing service and a sensor data sharing message (SDSM) may be used. In the sensor-sharing service, an infra sensor (e.g., camera, Lidar) perceives a situation of a blind spot of a vehicle such as a downtown intersection and a road junction, and perceived information of the infra sensor is forwarded to the vehicle via vehicle-to-everything (V2X) communication. The SDSM is a message standard for forwarding such perceived information. The sensor-sharing service and the SDSM are defined in SAE J3224 “V2X Sensor-Sharing for Cooperative and Automated Driving”.

According to SAE J3224 “V2X Sensor-Sharing for Cooperative and Automated Driving”, which is the related art, an infra sensor may transmit detected attributes of each object to a vehicle by using the SDSM. For example, attributes include at least one of an object identifier (ID), an object type, a current position, a moving speed, a movement heading, or an object size. Each of the attributes may be included in a corresponding field of SDSM.

The sensor-sharing service may be defined to update object detection information at intervals of 100 ms and transmit an SDSM every 100 ms. For example, the SDSM may be transmitted based on the communication technology of 3GPP LTE C-V2X or 5G NR V2X. One SDSM may be transmitted by being allocated to one subframe with intervals of 1 ms. Accordingly, one SDSM cannot be transmitted over a plurality of subframes. In other words, one SDSM cannot be transmitted by being divided into a plurality of subframes.

When the number of objects detected on a road increases, the payload of an SDSM including information on the objects increases significantly. Accordingly, the SDSM may be difficult to transmit in one subframe. For example, in 3GPP LTE V2X using 20 MHz frequency band, an SDSM transmitted in a subframe with 1 ms interval may include information on up to 40 objects. In a downtown area with traffic congestion, the number of detected objects may exceed 40. In this case, information on only 40 objects is transmitted every 100 ms, but information on the remaining objects is not transmitted. Accordingly, information on a plurality of objects, which is generated at intervals of 100 ms, should be compressed. When compressed representations are used, the number of objects, which are actually transmissible, may increase.

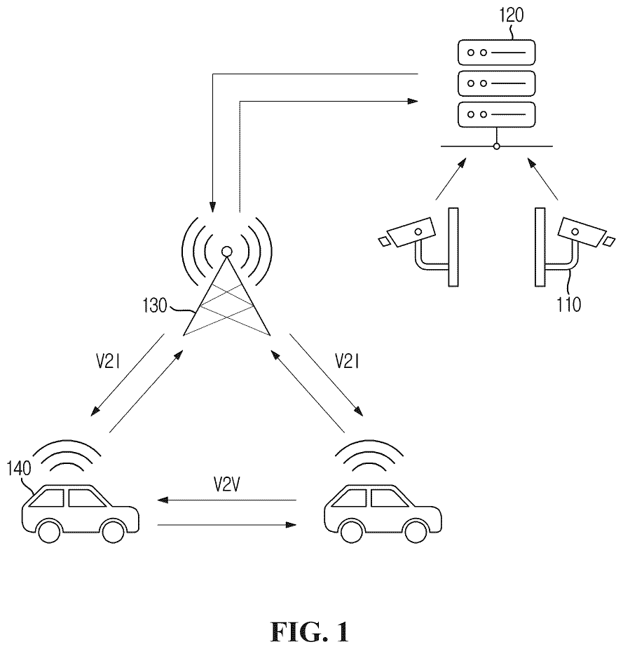

FIG. 1 illustrates an example of a sensor-sharing service system. Referring to FIG. 1, a sensor-sharing service system includes an infra sensor 110, a multi-access edge computer (MEC) 120, a base station 130, and a vehicle 140. The infra sensor 110 is installed in a fixed position (e.g., roadside) and is a sensor for sensing objects such as nearby pedestrians and vehicles. The infra sensor 110 senses a nearby object. The infra sensor 110 may include at least one of a camera, Lidar or radar. The infra sensor 110 may sensor an object by using at least one of a camera, Lidar or radar. The infra sensor 110 may obtain object information by sensing an object. Herein, the object information refers to information on an object obtained by the sensor. The infra sensor 110 may transmit object information to the MEC 120. To this end, the infra sensor 110 is connected to the MEC 120 through at least one means of wired or wireless communication.

The infra sensor 110 may obtain attribute information of a detected object. For example, the attribute information of the object may include at least one of the type, position, speed, acceleration, heading or size of the object.

The MEC 120 generates an SDSM by using object information received from the infra sensor 110. The MEC 120 may obtain information related to a detected object by using object information. For example, the attribute information of the object may include at least one of the type, position, speed, acceleration, direction or size of the object. To generate an SDSM, the MEC 120 may group objects based on attribute information of each of the objects. Grouping refers to an operation of binding objects with similar attributes into one group. Through grouping, the MEC 120 may include a plurality of objects in an SDSM as if they are one object. In other words, the number of objects included in an SDSM may be increased. Grouping may be referred to as clustering, and a group generated through grouping may be referred to as a cluster.

The base station 130 receives an SDSM and transmits the SDSM to the vehicle 140. The base station 130 may receive an SDSM from the MEC 120 by using at least one means of wired or wireless communication. The base station 130 may transmit an SDSM to the vehicle 140 wirelessly. The base station 130 may transmit an SDSM to the vehicle 140 based on a procedure defined in a standard such as 3GPP LTE C-V2X or 5G NR V2X.

The vehicle 140 receives an SDSM from the base station 130 or another vehicle. The vehicle 140 may include an on-board unit (OBU). For example, the vehicle 140 may receive an SDSM from the base station 130 or another vehicle by using the OBU. The vehicle 140 may transmit an SDSM to another vehicle by using the OBU. The vehicle 140 may detect a nearby object based on an SDSM. In other words, the vehicle 140 may detect a nearby object by obtaining attribute information of the object included in an SDSM.

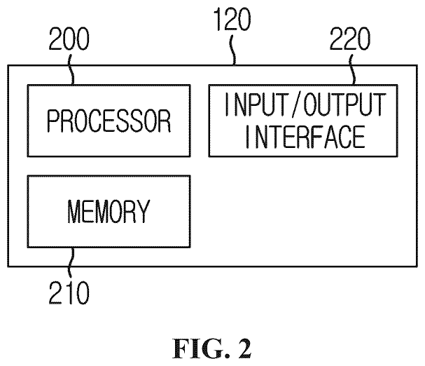

FIG. 2 illustrates a structure of an MEC.

Referring to FIG. 2, the MEC 120 includes a processor 200, a memory 210, and an input/output interface 220. The MEC 120 may include at least one of each of the components. For example, the MEC 120 may include one processor and a plurality of memories. As another example, the MEC 120 may include a plurality of processors, a plurality of memories, and an input/output interface.

The memory 210 is connected to the processor 200. The memory 210 may store various forms of data, signals, messages, information, programs, codes, instructions and/or commands. The memory 210 may include at least one or more of a read only memory (ROM), a random access memory (RAM), an erasable programmable read only memory (EPROM), a flash memory, a cache memory, a computer-readable storage medium, and a combination thereof. The memory 210 may be located at least one of inside and outside the processor 200. For example, among a plurality of the memories 210, some may be located inside the processor 200, and others may be located outside the processor 200. In addition, the memory 210 may be connected to one or more processors 200 through various technologies such as wired or wireless connection.

According to an embodiment of the present disclosure, the memory 210 may include a main memory and a secondary storage. For example, a management device 100 may include, as a main memory, a RAM that is a volatile memory. The management device 100 may include, as a secondary storage, a hard drive that is a non-volatile memory. Herein, the volatile memory is used as the main memory, and the non-volatile memory is used as the secondary storage.

The processor 200 may be implemented by hardware, firmware, software, or a combination thereof. As an example, at least one or more of an application specific integrated circuit (ASIC), one or more digital signal processor (DSPs), a digital signal processing device (DSPD), a programmable logic device (PLD), field programmable gate arrays (FPGA) and a combination thereof may be included in the processor 200. The descriptions, functions, procedures, proposals, methods and/or operating flowcharts disclosed herein may be implemented by the processor 200 through firmware or software, and the firmware or the software may be implemented to include modules, procedures, functions and the like. Firmware or software, which is configured to implement the descriptions, functions, procedures, proposals, methods and/or operating flowcharts disclosed herein, may be included in the processor 200 or stored in the memory 210 and driven by the processor 200. The descriptions, functions, procedures, proposals, methods and/or operating flowcharts disclosed herein may be implemented by firmware or software in forms of codes, commands and/or set of commands.

The processor 200 may control at least one of the memory 210 and the input/output interface 220 and execute commands stored in at least any one of the memory 210 and the processor 200, thereby implementing at least one or more of the procedures, proposals, methods and operating flowcharts of the present disclosure.

The input/output interface 220 inputs or outputs information or a signal. The input/output interface 220 may include a device for inputting and outputting information or a signal. For example, the input/output interface 230 may include at least one of a monitor, a keyboard, a touch display, a mouse, a speaker, a microphone, or a camera but is not limited thereto. As another example, the input/output interface 220 may include at least one of a port for wired or wireless connection with another device, a transceiver, or a connector. The input/output interface 220 is connected with any one or more of the memory 210 and the processor 200 wired or wirelessly. The input/output interface 220 may input or output information or a signal based on control of the processor 200. According to an embodiment of the present disclosure, the MEC 120 may be connected with an infra sensor and a base station by using the input/output interface 220. The MEC 120 may receive attribute information of an object from an infra sensor by using the input/output interface 220 and transmit an SDSM to a base station.

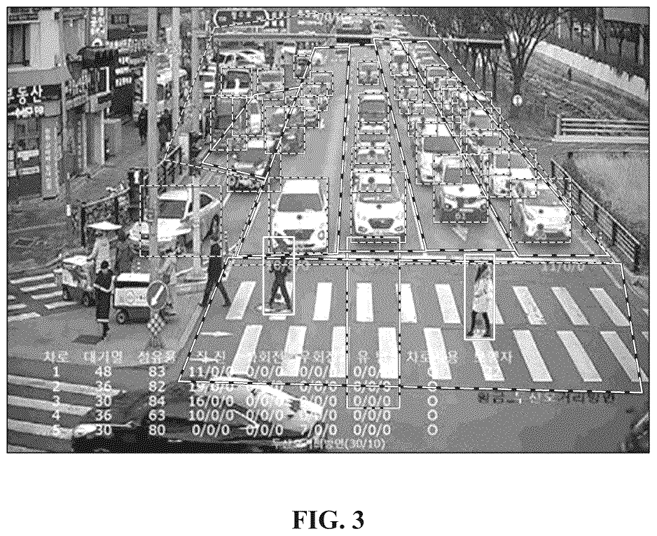

FIG. 3 illustrates an example of object detection according to an embodiment of the present disclosure.

FIG. 3 illustrates a result of object detection performed by an MEC (e.g., the MEC 120 of FIG. 1) based on an image obtained by a camera. Herein, the object detection refers to an operation by which a computer or a processor analyzes information obtained from a sensor, identifies at least one object, and obtains information on the identified object. Object detection may be performed by an artificial intelligence (AI) model or an AI algorithm. The AI model or the AI algorithm may refer to a program, an algorithm, or an operating procedure that is performed by a computer or a processor. The AI model or the AI algorithm may include an artificial neural network. Referring to FIG. 3, object detection may be performed using a bounding box. An MEC may detect objects such as multiple vehicles, pedestrians, road lanes and crosswalks. In a sensor-sharing service, an MEC should transmit information on each of detected objects to a vehicle by using an SDSM. However, if more than 40 objects are detected, information on each of the detected objects cannot be transmitted via one SDSM. To solve this problem, among the detected objects, objects with similar attribute information may be grouped according to an embodiment of the present disclosure.

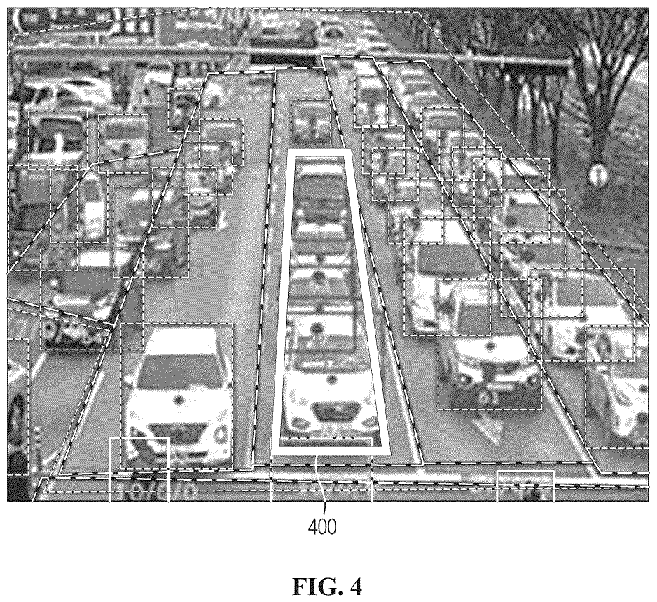

FIG. 4 illustrates an example of grouping according to an embodiment of the present disclosure. Referring to FIG. 4, an MEC (e.g., the MEC 120 of FIG. 1) may group stationary vehicles located on a same lane into one group 400. Objects included in the group 400 are similar with respect to type, movement heading, speed and acceleration. An MEC may transmit a representative value of a plurality of objects in the group 400 to a base station by using an SDSM. As the one group 400 includes a representative value of information on a plurality of objects, the number of objects in an SDSM decreases. That is, information on more objects may be transmitted by using one SDSM. In FIG. 4, vehicles located on a same lane are grouped into one group, but a grouping method is not limited thereto. For example, one group may include vehicles distributed on a plurality of lanes. In addition, objects to be grouped may be vehicles or pedestrians. Objects to be grouped may be stationary or moving.

Hereinafter, a grouping procedure will be described in detail.

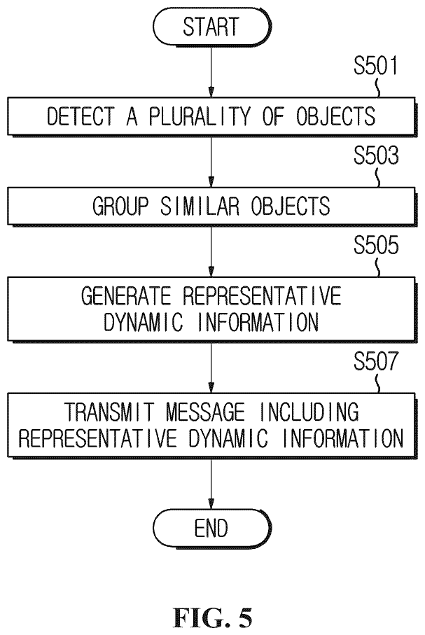

FIG. 5 illustrates an example of an information transmission procedure of a plurality of objects according to an embodiment of the present disclosure. FIG. 5 illustrates a procedure performed by an MEC (e.g., the MEC 120 of FIG. 1).

Referring to FIG. 5, at step S501, the MEC detects a plurality of objects. The MEC may detect a plurality of objects based on information received from an infra sensor (e.g., the infra sensor 110 of FIG. 1). For example, the MEC may detect a plurality of objects based on an image received from the infra sensor. The MEC may receive successive images from the infra sensor. The MEC may obtain attribute information of each of the plurality of objects based on the successive images.

At step S503, the MEC groups similar objects. For example, the MEC may group objects with similar dynamic information. Dynamic information includes information related to a movement of an object. The MEC may generate at least one group through grouping. One group has unique dynamic information, not dynamic information of each object. The group may be represented as one object on an image obtained from a camera. That is, the group may be represented as one object with a polygonal shape on an image.

At step S505, the MEC generates representative dynamic information. The representative dynamic information refers to unique dynamic information of one group. In other words, it refers to dynamic information representing one group. Representative dynamic information may be generated based on dynamic information of each object. For example, a representative position may be generated based on a position of each object.

At step S507, the MEC transmits a message including the representative dynamic information. Herein, the message may include an SDSM. The message may include at least one of representative dynamic information, a representative object type, a representative object ID, or additional information. The representative object type may be identical with a type of objects constituting a group. The representative object ID is a unique ID of the group and may be different from an object ID of the objects in the group.

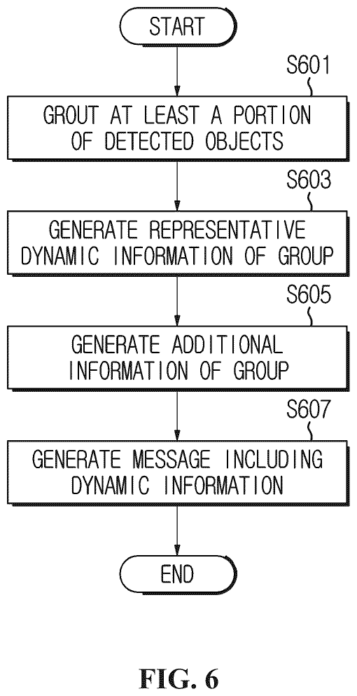

FIG. 6 illustrates an example of a group procedure according to an embodiment of the present disclosure. FIG. 6 illustrates a procedure performed by an MEC (e.g., the MEC 120 of FIG. 1). The procedure described in FIG. 6 may correspond to steps S503 to S505 of FIG. 5.

Referring to FIG. 6, at step S601, the MEC groups at least a portion of detected objects. The MEC may group objects with a same object type and similar dynamic information. Herein, the dynamic information may include at least one of a position of an object, a speed of an object, a heading of an object, or an acceleration of an object. In addition, the MEC may group objects adjacent to each other. For example, the MEC may group pedestrians for which a distance between objects is shorter than a predefined threshold. Herein, the predefined threshold may be different according to the type and dynamic feature of an object. In other words, the MEC may group objects that are adjacent to each other, have similar dynamic information, and have a same object type.

At step S603, the MEC generates representative dynamic information of a group. Herein, the dynamic information may include at least one of a representative position, a representative speed, a representative heading, or a representative acceleration. Representative dynamic information may be generated based on dynamic information of objects. For example, a representative position may be generated based on a position of objects constituting a group.

At step S605, the MEC generates additional information of the group. Herein, the additional information includes information related to the objects included in the group. For example, the additional information may include at least one of a shape of the group, the number of objects in the group, a position of each of the objects, and a size of each of the objects.

At step S607, the MEC generates a message including the representative dynamic information. For example, the MEC may generate a message including representative dynamic information, a representative object ID, a representative object type, additional information or a measurement time. Herein, the measurement time may be identical with a measurement time of the objects in the group. The generated message may include an SDSM.

A message generated by the procedure of FIG. 6 may not include additional information. If a generated message includes no additional information, step S605 may be omitted. In other words, the MEC may generate a message for a sensor-sharing service without performing step S605.

In a sensor-sharing service system according to the present disclosure, representative dynamic information may include at least one of a representative position, a representative speed, a representative heading, or a representative acceleration. Representative dynamic information may be generated based on dynamic information of objects. Additional information may include at least one of a shape of the group, the number of objects in the group, a position of each of the objects, and a size of each of the objects. In an SDSM, additional information may be distinguished according to a type of grouped objects. That is, in an SDMS, additional information may be indicated in a separate field according to a type of grouped objects.

A representative position may be generated based on a position of objects included in a group. For example, a representative position may include at least one of an average or variance of coordinates representing positions of respective objects. As another example, a representative position may be a center point of a group. When a representative position is a center point of a group, the center point of the group may be a center of the coordinates of respective vertexes in a polygon that is the shape of the group.

A representative speed may be generated based on velocities of objects included in a group. For example, a representative speed may be an average of velocities of respective objects in a group. As another example, a representative speed may include an average and variance of velocities of respective objects in a group.

A representative speed may be generated based on velocities of objects included in a group. For example, a representative speed may be an average of velocities of respective objects in a group. As another example, a representative speed may include an average and variance of velocities of respective objects in a group.

A representative acceleration may be generated based on accelerations of objects included in a group. For example, a representative acceleration may be an average of accelerations of respective objects in a group. As another example, a representative acceleration may include an average and variance of accelerations of respective objects in a group.

A shape of a group represents a shape of a group shown in an image. For example, a shape of a group may include coordinates of respective vertexes of a polygon shown in an image. A shape of a group may be determined according to a type of objects in a group. Hereinafter, examples of shapes of groups according to a type of objects will be described, but the present disclosure is not limited thereto. In other words, groups with various shapes may be generated based on at least one of the type, speed, or position of objects.

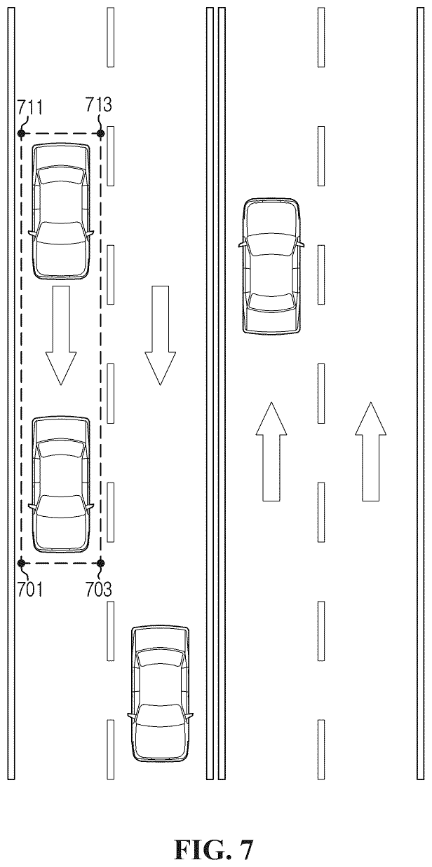

FIG. 7 illustrates a shape of a group including vehicles as objects according to an embodiment of the present disclosure.

Referring to FIG. 7, when objects included in a group are vehicles, the group may have a rectangular shape. When objects are vehicles, the shape of the group may be a smallest rectangle including all the objects of the group. For example, a shape of a group including vehicles on a same lane may be a rectangle formed by connecting a left front vertex 701 and a right front vertex 703 of a bounding box of a foremost vehicle 700 in the group and a left front vertex 711 and a right front vertex 713 of a bounding box of a rearmost vehicle 710.

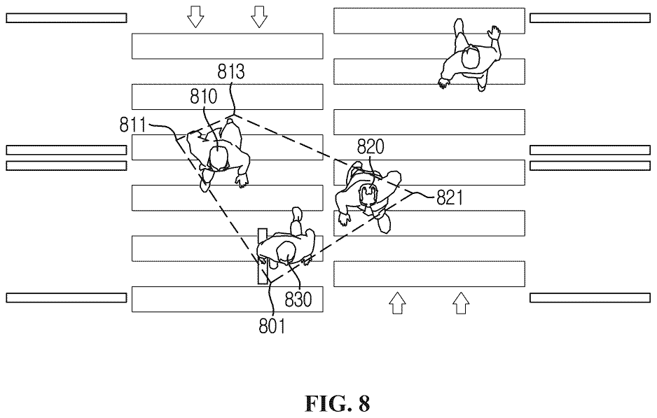

FIG. 8 illustrates a shape of a group including pedestrians as objects according to an embodiment of the present disclosure.

Referring to FIG. 8, when objects included in a group are pedestrians, the group may have a shape of a polygon with more or less vertexes than rectangle. When objects are pedestrians, the shape of a group may be a polygon that has a smaller number of vertexes than a predefined polygon. For example, when objects are pedestrians, the shape of a group may be a polygon with 4 to 8 vertexes. When objects are pedestrians, the shape of a group may be a polygon with a smallest area among polygons including all the objects. The shape of a group may be generated based on a bounding box. For example, the shape of a group may be a polygon formed by connecting a center point 801 of a front edge of a bounding box for a foremost pedestrian 800, a center point 811 of a left edge of a bounding box for a leftmost pedestrian 810, a center point 813 of a rear edge of a bounding box for a rearmost pedestrian 810, and a center point 821 of a right edge of a bounding box for a rightmost pedestrian 820.

In a sensor-sharing service system according to the present disclosure, an MEC may group objects with similar dynamic information. Herein, the objects with similar dynamic information refer to objects for which a difference between each piece of dynamic information does not exceed a threshold. For example, objects with a speed difference not exceeding a speed threshold and a heading difference not exceeding a heading threshold may be grouped. The number of pieces of similar dynamic information required for grouping may be changed. The MEC may group objects that have one similar type of dynamic information among multiple types of dynamic information. On the other hand, the MEC may group objects that are similar in every dynamic information. The number of pieces of similar dynamic information required for grouping may be different according to a type of objects.

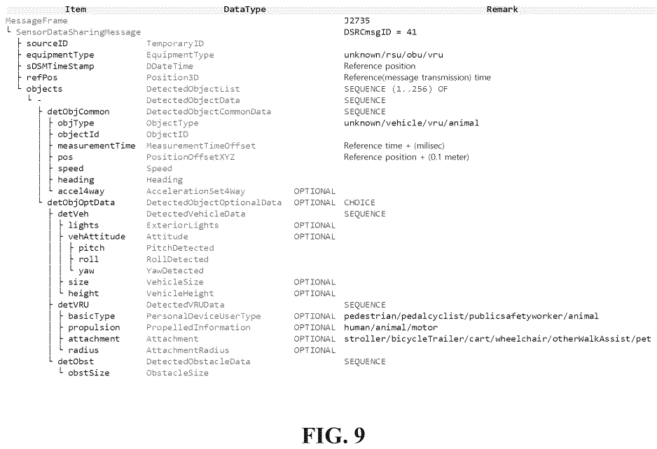

FIG. 9 illustrates an example of an SDSM to which grouping is not applied.

Referring to FIG. 9, an SDSM includes an “objects” field. The “objects” field may include at least one field of “objtype”, “objectId”, “pos”, “speed”, “heading”, or “acel4way”. The above-described fields indicate an object type, an object ID, an object position, an object speed, an object heading, and an object acceleration, respectively. An SDSM includes at least one field of “objtype”, “objectId”, “pos”, “speed” or “heading” without failure. Additionally, the “objects” field includes a “detObjOptData” field. The “detObjOptData” field may indicate at least one of the size, height or posture of an object. The “detObjOptData” field may not be included in an SDSM. In other words, the “detObjOptData” field may be an optional field.

The present disclosure proposes an additional value that may be included in an SDSM to represent grouped objects.

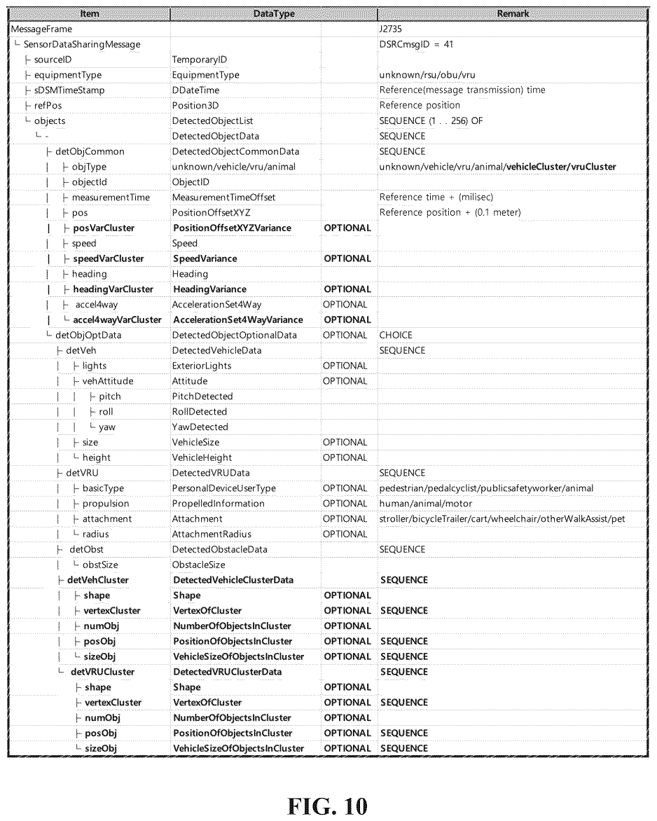

FIG. 10 illustrates an example of an SDSM to which grouping is applied. Referring to FIG. 10, the “objtype” field of an SDSM, to which grouping is not applied, may have a value of “unknown”, “vehicle”, “vulnerable road user (vru)”, or “animal”. According to an embodiment of the present disclosure, the objtype” field of an SDSM may have a value of “unknown”, “vehicle”, “vulnerable road user (vru)”, “animal”. “vehicleCluster” or “vruCluster”. In an SDSM, when an “objtype” field has a value of “vehicleCluster” or “vruCluster”, “pos”, “speed”, “heading” and “aceel4way” fields may indicate the representative position, representative speed or representative heading of a group respectively. In other words, when grouping is applied, dynamic information included in an SDSM may be representative dynamic information. Additionally, when grouping is applied, an SDSM may include positions, speeds, headings, and variance of accelerations of objects in a group. Additionally, when grouping is applied, an SDSM may include additional information. For example, at least one field of shape (“shape”), the number of objects (“numObj”), a position of each of the objects (“posObj”), or a size of each of the objects (“sizeObj”) may be included in an SDSM. Additionally, additional information may be distinguished into “detVehCluster” for vehicle objects and “detVRUCluster” for pedestrian objects. In other words, an SDSM may separately include additional information for a case in which grouped objects are vehicles and for a case in which grouped objects are pedestrians.

In the present disclosure, grouping of objects and generation of an SDSM are described to be performed by an MEC, but at least one of the operations, that is, grouping of objects and generation of an SDSM, may be performed by another device different from an MEC. For example, grouping of objects may be performed by an MEC, and generation of an SDSM may be performed by a base station. On the other hand, a base station may group objects and generate an SDSM. For example, when grouping of objects is performed by an MEC and generation of an SDSM is performed by a base station, the MEC may detect objects, determine objects to be grouped, perform grouping, and obtain representative dynamic information of the objects to be grouped. The base station may receive the representative dynamic information of the objects to be grouped and an ID of each of the objects to be grouped and generate the SDSM by using the received representative dynamic information and ID.

Although exemplary methods of the present disclosure are represented as a series of operations for clarity of description, the order of the steps is not limited thereto, and when necessary, the illustrated steps may be performed simultaneously or in a different order. In order to realize the method according to the present disclosure, other steps may be added to the illustrative steps, some steps may be excluded while the remaining steps may be included, or some steps may be excluded while additional steps may be included.

The various embodiments of the present disclosure are not intended to list all possible combinations, but to illustrate representative aspects of the present disclosure. The matters described in the various embodiments may be applied independently or in a combination of two or more.

Also, the various embodiments of the present disclosure may be implemented by hardware, firmware, software, or a combination thereof. With hardware implementation, the embodiment may be implemented by using at least one selected from a group of application specific integrated circuits (ASICs), digital signal processors (DSPs), digital signal processing devices (DSPDs), programmable logic devices (PLDs), field programmable gate arrays (FPGAs) general-purpose processors, controllers, micro controllers, microprocessors, etc.

The scope of the present disclosure includes software or machine-executable instructions (e.g., an operating system, an application, firmware, a program, etc.) that cause operations according to the methods of the various embodiments to be performed on a device or a computer, and includes a non-transitory computer-readable medium storing such software or instructions to execute on a device or a computer.

What is claimed is:

1. A method for providing a sensor data sharing message based on a sensor-sharing service, the method comprising:
detecting objects based on information obtained from a sensor;
generating an object group by grouping at least a portion the objects; and
generating a sensor data sharing message including information on the objects,
wherein the sensor data sharing message includes representative dynamic information that is generated based on information on each of objects included in the object group.

2. The method of claim 1, wherein the representative dynamic information includes at least one of a representative position, a representative heading, a representative speed, or a representative acceleration, and
wherein the representative dynamic information corresponds to a position, a heading, a speed, or an acceleration of the object group.

3. The method of claim 1, wherein the sensor data sharing message includes a type and an ID of the object group, and
wherein the type of the object group is identical to a type of the objects included in the object group.

4. The method of claim 1, wherein the grouping is performed based on dynamic information of the objects, and
wherein the object group includes a same type of objects.

5. The method of claim 4, wherein the generating of the object group comprises:
calculating a difference of the dynamic information of the objects; and
generating the object group by grouping objects with the difference being equal to or below a threshold.

6. The method of claim 5, wherein the dynamic information includes a position, a speed, a movement heading, or an acceleration.

7. The method of claim 1, wherein the sensor data sharing message further includes additional information on the object group, and
wherein the additional information includes at least one of a shape of the object group, a number of the objects included in the object group, a position of each of the objects included in the object group, and a size of each of the objects included in the object group.

8. A sensor sharing apparatus comprising:
at least one processor; and
a memory for storing instructions,
wherein the at least one processor is configured to:
by executing the instructions,
detect objects based on information obtained from a sensor,
generate an object group by grouping at least a portion the objects, and
generate a sensor data sharing message including information on the objects, and
wherein the sensor data sharing message includes representative dynamic information that is generated based on information on each of objects included in the object group.

9. The sensor sharing apparatus of claim 8, wherein the representative dynamic information includes at least one of a representative position, a representative heading, a representative speed, or a representative acceleration, and
wherein the representative dynamic information corresponds to a position, a heading, a speed, or an acceleration of the object group.

10. The sensor sharing apparatus of claim 8, wherein the sensor data sharing message includes a type and an ID of the object group, and
wherein the type of the object group is identical to a type of the objects included in the object group.

11. The sensor sharing apparatus of claim 8, wherein the grouping is performed based on dynamic information of the objects, and
wherein the object group includes a same type of objects.

12. The sensor sharing apparatus of claim 11, wherein the processor is further configured to:
calculate a difference of the dynamic information of the objects, and
generate the object group by grouping objects with the difference being equal to or below a threshold.

13. The sensor sharing apparatus of claim 12, wherein the dynamic information includes a position, a speed, a movement heading, or an acceleration.

14. The sensor sharing apparatus of claim 8, wherein the sensor data sharing message further includes additional information on the object group, and
wherein the additional information includes at least one of a shape of the object group, a number of the objects included in the object group, a position of each of the objects included in the object group, and a size of each of the objects included in the object group.
